(19) United States
(12) Patent Application Publication
(10) Pub. No.: US 2026/0150822 A1
(43) Pub. Date: Jun. 4, 2026

(54) PORTABLE FISHING NET

(71) Applicant: Yuerui Xu, Jieyang City (CN)

(72) Inventor: Yuerui Xu, Jieyang City (CN)

(21) Appl. No.: 18/967,922

(22) Filed: Dec. 4, 2024

(51) Int. Cl. A01K 77/00

(52) U.S. Cl. CPC A01K 77/005

(57) ABSTRACT

A portable fishing net includes a net frame, an insertion block, a slidable unlocking member, and a rod member. The insertion block is installed on the net frame. The slidable unlocking member is slidably arranged on the rod member. The slidable unlocking member is capable of being inserted into the insertion block. When the slidable unlocking member is inserted into the insertion block, the rod member and the net frame are in a locked state. When the slidable unlocking member is disengaged from the insertion block, the rod member is movable relative to the net frame, and the rod member is movable to be stacked on the net frame.

### TECHNICAL FIELD

The present invention relates to the technical field of fishing gear, particularly to a portable fishing net applied in the technical field of fishing gear.

### BACKGROUND ART

With the popularization of outdoor sports, especially in fishing and wilderness exploration activities, portable fishing nets, as a common tool, are widely used in fishing, catching aquatic life and other activities. However, there are a plurality of shortcomings in the use and storage of existing portable fishing nets.

Firstly, the design of a folding structure of existing fishing nets often makes the operation cumbersome and is not convenient enough for quick unfolding or storage. Although some fishing nets adopt a foldable design, due to the complex structure, users often need a plurality of steps to complete the operation of unfolding or storage, which affects the convenience of use. Secondly, the existing fishing nets are usually made of a single buoyancy material design, which cannot provide sufficient support and buoyancy during the use of the fishing nets. Although some fishing nets are designed to use buoyancy materials, the arrangement of these buoyancy materials is often not optimized, resulting in uneven buoyancy distribution when the fishing nets float in water, which affects the effectiveness of use. At the same time, a length of a rod of an existing fishing net is usually fixed and cannot be adjusted according to different usage environments, seriously limiting the scope of application of the fishing net.

Therefore, existing portable fishing nets still need to be improved in terms of folding structure simplification, rod length adjustment, buoyancy distribution optimization and locking mechanism to provide a portable fishing net with a simple structure, a low manufacturing cost, and a good using effect.

### SUMMARY

In order to solve the problems mentioned above in the prior art, a portable fishing net is provided in the present invention. Through the cooperation of a insertion block and a slidable unlocking member, a rod member is movable relative to a net frame and is in a folded state, thereby achieving a portable folding function of the fishing net. A bottom portion of the net frame and a tail end of an extending rod are respectively provided with a first floating member and a second floating member, solving the problems of uneven buoyancy and cumbersome folding.

The technical solution adopted by the present invention to solve its technical problems is as follows.

A portable fishing net includes a net frame, an insertion block, a slidable unlocking member, and a rod member. The insertion block is installed on the net frame. The slidable unlocking member is slidably arranged on the rod member. The slidable unlocking member is capable of being inserted into the insertion block. When the slidable unlocking member is inserted into the insertion block, the rod member and the net frame are in a locked state. When the slidable unlocking member is disengaged from the insertion block, the rod member is movable relative to the net frame, and the rod member is movable to be stacked on the net frame.

As an improvement of the present invention, the rod member includes a connecting rod and an extending rod. The slidable unlocking member is slidably arranged on the connecting rod. The connecting rod is pivotally connected into the insertion block. The extending rod is slidable relative to the connecting rod.

As an improvement of the present invention, the rod member further includes a locking member. The locking member is arranged between the connecting rod and the extending rod. The locking member is used for fixing the connecting rod and the extending rod.

As an improvement of the present invention, a plurality of openings are defined in the insertion block. When the slidable unlocking member is inserted into the insertion block through the plurality of openings, the connecting rod and the net frame are in a locked state.

As an improvement of the present invention, the opening includes a first opening, a second opening, and a third opening. When the slidable unlocking member is inserted into the insertion block through the first opening, the connecting rod and the extending rod are in a usage state relative to the net frame. The slidable unlocking member is capable of moving to the third opening through the second opening. When the slidable unlocking member is inserted into the insertion block through the third opening, the rod member and the net frame are in a folded state.

As an improvement of the present invention, a bottom portion of the net frame includes a first floating member, and the extending rod is provided with a second floating member. The first floating member is installed on the net frame, and the second floating member is sleeved on a tail end of the extending rod.

As an improvement of the present invention, the insertion block is also provided with an insertion slot. The insertion slot is penetrated between the first opening and the third opening. The connecting rod is capable of being pivotally connected into the insertion slot through the first opening and the third opening, and the slidable unlocking member is capable of being inserted into the insertion slot.

As an improvement of the present invention, the bottom portion of the net frame is also equipped with a fishing net. The fishing net is fixedly connected to a bottom portion of the first floating member.

As an improvement of the present invention, the net frame includes a first part and a second part. The first part is in a closed form, and the second part includes two free ends. The insertion block used for detachably fixing the connecting rod is connected to the two free ends respectively.

As an improvement of the present invention, both sides within the insertion slot are provided with position limiting protrusions. The position limiting protrusion is arranged along a length direction of the insertion slot. When the connecting rod is pivotally connected to the insertion slot, the connecting rod is partially positioned between the position limiting protrusions.

As an improvement of the present invention, the first part is substantially rectangular, and the second part is substantially in an arc shape.

As an improvement of the present invention, a length of the position limiting protrusion is less than a length of the insertion slot.

As an improvement of the present invention, the slidable unlocking member includes a locking part and a sliding part. The sliding part and the locking part are slidably arranged on the connecting rod. When the locking part is inserted into the insertion block, the sliding part abuts against the insertion block.

As an improvement of the present invention, the slidable unlocking member is internally equipped with a restoration spring. The connecting rod is equipped with a stop portion. The stop portion is positioned inside the slidable unlocking member. The restoration spring is sleeved on the connecting rod. A first end of the restoration spring abuts against an inner wall of an end portion of the locking part, and a second end of the restoration spring abuts against the stop portion. When the sliding part is subjected to an external force, the sliding part is capable of driving the locking part to disengage from within the insertion block. The restoration spring is used for driving the sliding part and the locking part to return to an initial position.

As an improvement of the present invention, the sliding part is provided with a hook, and the hook is bent and extends along an end portion of the sliding part in a direction towards the extending rod. As an improvement of the present invention, the connecting rod is provided with a hook, and the hook is bent and extends along the connecting rod in a direction towards the extending rod.

As an improvement of the present invention, a rotating shaft is also provided inside the insertion block. A rotating hole adapted to the rotating shaft is defined in the connecting rod. The rotating hole cooperates with the rotating shaft, so that the connecting rod is pivotally connected into the insertion block.

As an improvement of the present invention, a tail end of the extending rod is provided with a hanging rope.

As an improvement of the present invention, both the first floating member and the second floating member are made of floating materials.

As an improvement of the present invention, the fishing net is equipped with a plurality of grids. The grids are all arranged in a diamond shape.

Beneficial effects of the present invention are as follows. The portable fishing net is provided in the present invention. Through the cooperation of the slidable unlocking member and the insertion block, rapid locking and unlocking between the rod member and the net frame are achieved, the rod is movable to be stacked on the net frame, and the operation is simple and convenient, solving the problems of complex structure and inconvenient operation in the prior art. Through the sliding and cooperation between the connecting rod and the extending rod, as well as the fixing effect of the locking member, the length of the rod member is adjustable, which can avoid restrictions due to different usage scenarios and improve the applicability of the fishing net. By arranging the first floating member at the bottom portion of the net frame and the second floating member at the tail end of the extending rod, a dual buoyancy support structure is formed, effectively avoiding the problem of uneven buoyancy caused by a single floating member, and maintaining stable balance of the fishing net on the water surface.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a usage state diagram of a first embodiment of a portable fishing net of the present invention.

FIG. 2 is a folded state diagram of a first embodiment of a portable fishing net of the present invention.

FIG. 3 is a usage state diagram of a second embodiment of a portable fishing net of the present invention.

FIG. 4 is a schematic diagram of an overall structure of a portable fishing net of the present invention from an angle of view.

FIG. 5 is a cross-sectional view of FIG. 4.

FIG. 6 is a schematic diagram of an exploded structure of a first embodiment of a portable fishing net of the present invention.

FIG. 7 is an enlarged view of area A in FIG. 6.

FIG. 8 is a structural diagram of a slidable unlocking member and an insertion block of a portable fishing net of the present invention.

FIG. 9 is a perspective view of a bottom portion of an insertion block of a portable fishing net of the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

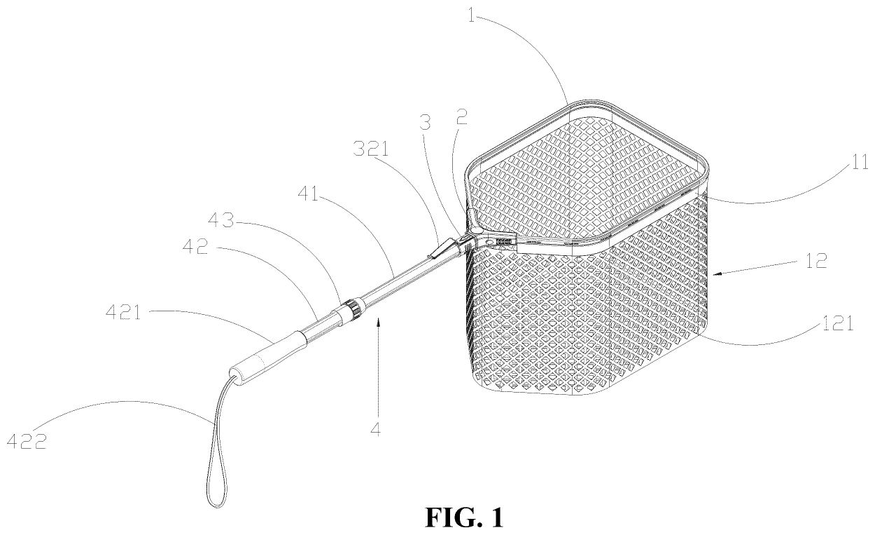

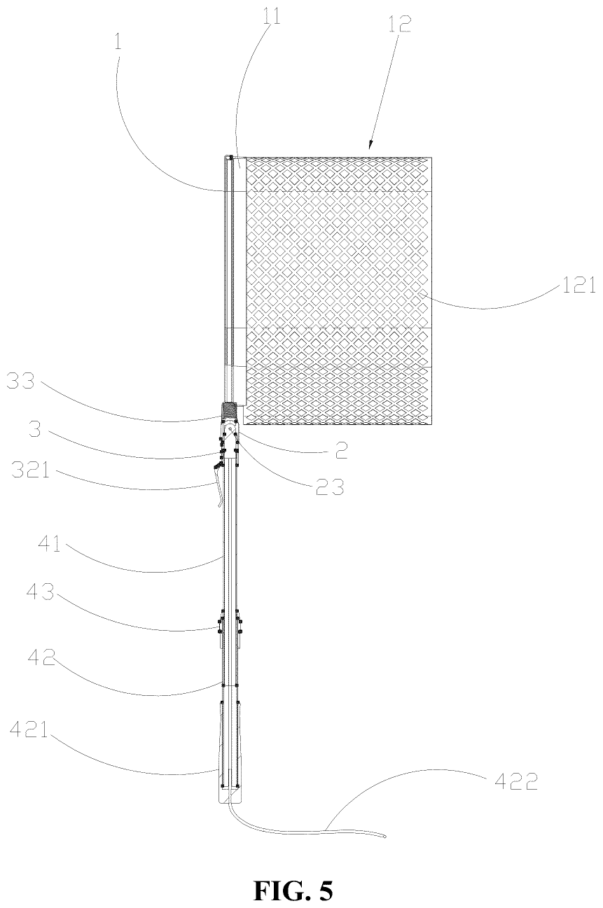

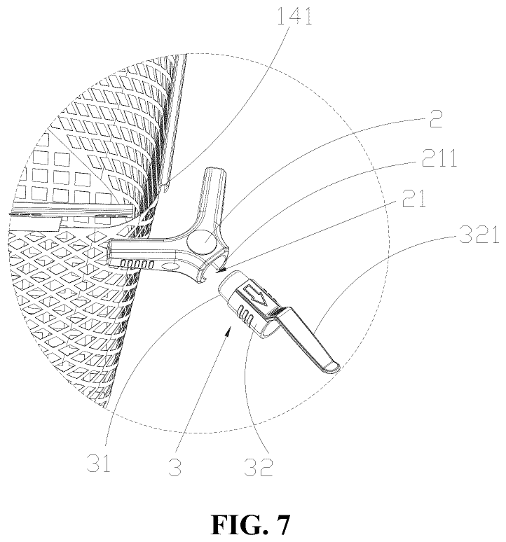

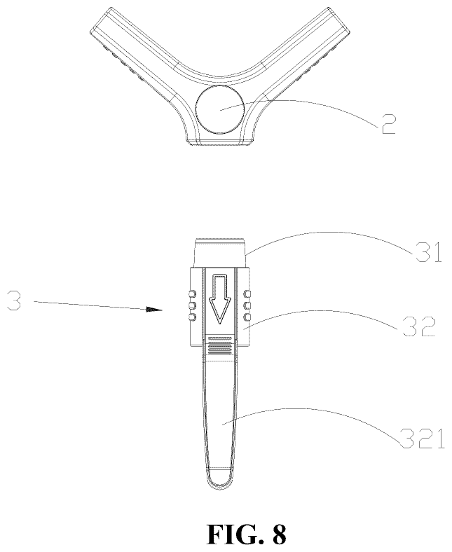

Referring to FIGS. 1-9, a portable fishing net is provided in the present invention. The portable fishing net includes a net frame 1, an insertion block 2, a slidable unlocking member 3, and a rod member 4. The insertion block 2 is installed on the net frame 1. The slidable unlocking member 3 is slidably arranged on the rod member 4. The slidable unlocking member 3 is capable of being inserted into the insertion block 2. When the slidable unlocking member 3 is inserted into the insertion block 2, the rod member 4 and the net frame 1 are in a locked state. When the slidable unlocking member 3 is disengaged from the insertion block 2, the rod member 4 is movable relative to the net frame 1, and the rod member 4 is movable to be stacked on the net frame 1.

Through the arrangement of the above structure, when in use, simply inserting the slidable unlocking member 3 into the insertion block 2 can lock the rod member 4 with the net frame 1, which is simple to operate. When folding is required, the slidable unlocking member 3 is pulled out from the insertion block 2, and then the rod member 4 can be flexibly rotated and folded to be stacked on the net frame 1, which is not only easy and convenient to operate, but also saves storage space and improves the portability of the product.

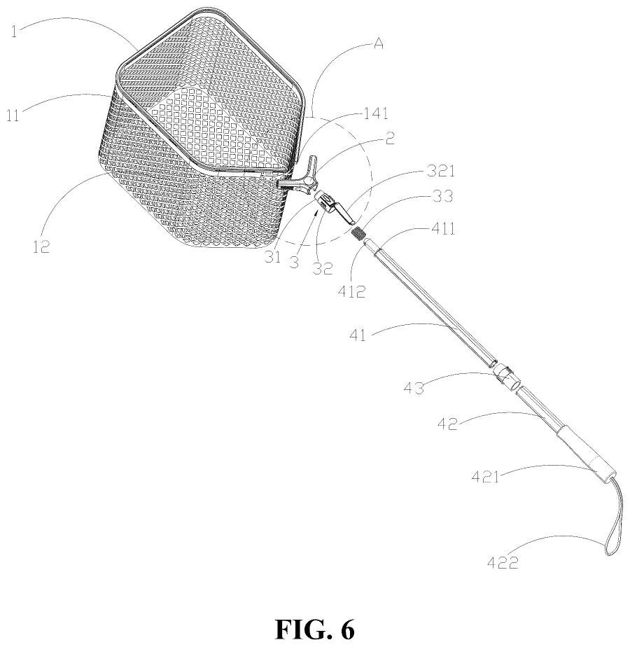

In this embodiment, as shown in FIG. 6, the rod member 4 includes a connecting rod 41 and an extending rod 42. The slidable unlocking member 3 is slidably arranged on the connecting rod 41. The connecting rod 41 is pivotally connected into the insertion block 2. The extending rod 42 is slidable relative to the connecting rod 41. Through the arrangement of the above structure, the extending rod 42 is preferably of a hollow structure, which allows the connecting rod 41 to slide adjustably within the extending rod 42, thereby changing a length of the rod member 4. The extending rod 42 is always slidably connected to the connecting rod 41 without being disengaged. At the same time, the connecting rod 41 is pivotally connected to the insertion block 2 to achieve rotation, which can make the operation of the fishing net more flexible.

In this embodiment, the rod member 4 further includes a locking member 43. The locking member 43 is arranged between the connecting rod 41 and the extending rod 42. The locking member 43 is used for fixing the connecting rod 41 and the extending rod 42. Through the arrangement of the above structure, a user can slide the connecting rod 41 inside the extending rod 42 to adjust a required length. When the length is determined, the connecting rod 41 and the extending rod 42 can be locked in a position of the desired length through the locking member 43, avoiding unexpected changes in the length of the rod member during use and ensuring more stable and reliable use.

In this embodiment, a plurality of openings 21 are defined in the insertion block 2. When the slidable unlocking member 3 is inserted into the insertion block 2 through the plurality of openings 21, the connecting rod 41 and the net frame 1 are in a locked state. Through the arrangement of the above structure, the slidable unlocking member 3 can be matched with the insertion block 2 through different openings 21, achieving quick switching between a usage state and a folded state. The operation is simple and intuitive, improving the convenience of the use of the product.

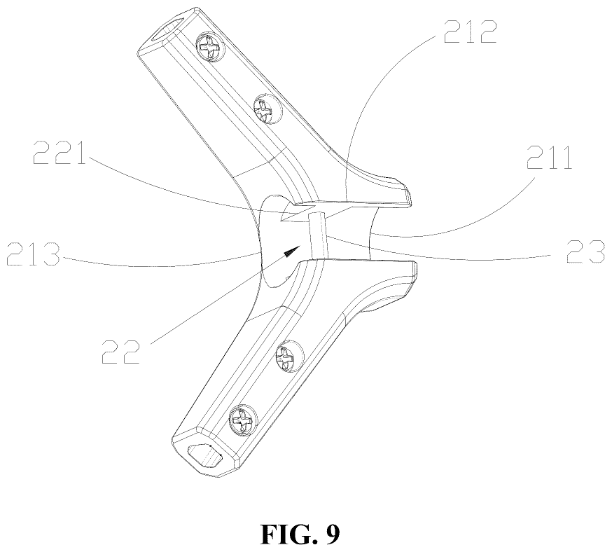

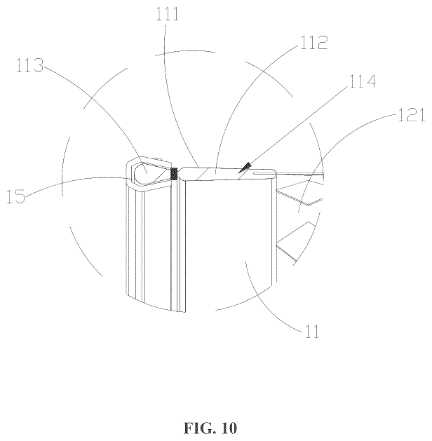

In this embodiment, as shown in FIG. 9, the opening 21 includes a first opening 211, a second opening 212, and a third opening 213. When the slidable unlocking member 3 is inserted into the insertion block 2 through the first opening 211, the connecting rod 41 and the extending rod 42 are in a usage state relative to the net frame 1. The slidable unlocking member 3 is capable of moving to the third opening 213 through the second opening 212. When the slidable unlocking member 3 is inserted into the insertion block 2 through the third opening 213, the rod member 4 and the net frame 1 are in a folded state. Through the arrangement of the above structure, when the slidable unlocking member 3 slides through the second opening 212, switching can be performed between the first opening 211 and the third opening 213. When the slidable unlocking member 3 is positioned in the first opening 211, the connecting rod 41 and the extending rod 42 are in the usage state with the net frame 1. When folding is needed, the slidable unlocking member 3 slides through the second opening 212 as a transition channel to the third opening 213, so that the rod member 4 and the net frame 1 form the folded state, achieving a portable storage function of the structure, and the operation is simple and convenient.

In this embodiment, a bottom portion of the net frame 1 includes a first floating member 11, and the extending rod 42 is provided with a second floating member 421. The first floating member 11 is installed on the net frame 1, and the second floating member 421 is sleeved on a tail end of the extending rod 42. Through the arrangement of the above structure, the first floating member 11 at the bottom portion of the net frame 1 and the second floating member 421 at the tail end of the extending rod 42 form a dual buoyancy support structure. The first floating member 11 is preferably designed with a double-layer structure, including an outer covering body and a built-in floating material. The outer covering body is made of water-resistant woven material, forming a closed covering cavity for accommodating the built-in floating material. An upper portion of the outer covering body of the first floating member 11 is provided with an installation block adapted to a slot of the net frame 1. A transverse dimension of the installation block is greater than an opening width in the slot of the net frame 1. Then, by fixing the insertion block 2 to two ends of the net frame 1 with screws, the first floating member 11 can be reliably prevented from detaching from the slot. The second floating member 421 may be detachably sleeved at the tail end of the extending rod 42. If the second floating member is damaged, it is convenient to replace the second floating member 421. The arrangement of the second floating member 421 can also prevent the extending rod 42 from sinking due to lack of buoyancy, keeping the fishing net stable and balanced on the water surface.

In this embodiment, as shown in FIG. 9, the insertion block 2 is also provided with an insertion slot 22. The insertion slot 22 is penetrated between the first opening 211 and the third opening 213. The connecting rod 41 is capable of being pivotally connected into the insertion slot 22 through the first opening 211 and the third opening 213. The slidable unlocking member 3 is capable of being inserted into the insertion slot 22. Through the arrangement of the above structure, the insertion slot 22 plays a guiding role, preventing the slidable unlocking member 3 from shifting, and improving the accuracy and reliability of operation.

In this embodiment, the bottom portion of the net frame 1 is also equipped with a fishing net 12. The fishing net 12 is fixedly connected to a bottom portion of the first floating member 11. Through the arrangement of the above structure, the fishing net 12 is fixedly installed at the bottom portion of the first floating member 11, and is connected to a bottom portion of the outer covering body of the first floating member 11 through a weaving process to form an integrated structure. This connection method not only has high connection strength, but also evenly distributes buoyancy on the fishing net 12. When the fishing net 12 is partially damaged and needs repair, the fishing net 12 can be replaced and maintained by disassembling the first floating member 11, which facilitates maintenance. The fishing net 12 obtains uniform buoyancy support from the first floating member 11, which keeps the fishing net 12 in a good unfolded state at all times, prevents the fishing net from being folded, and thus improves the capture efficiency.

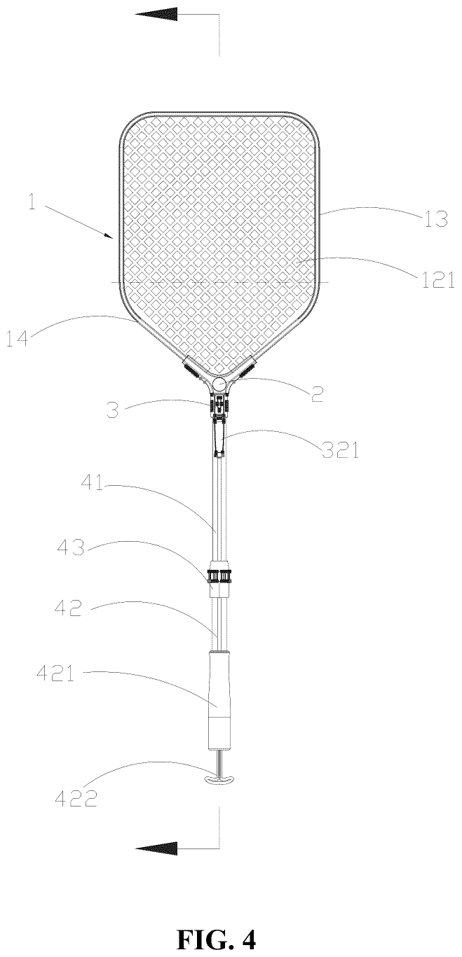

In this embodiment, as shown in FIG. 4, the net frame 1 includes a first part 13 and a second part 14. The first part 13 is in a closed form, and the second part 14 includes two free ends 141. The insertion block 2 used for detachably fixing the connecting rod 41 is connected to the two free ends 141 respectively. Through the arrangement of the above structure, the net frame 1 adopts an integrated design of the first part 13 and the second part 14. The first part 13 is in the closed form to increase overall strength, and the two free ends 141 of the second part 14 are respectively detachably connected to the insertion block 2 through screws. This design not only ensures structural strength, but also facilitates installation and disassembly, and provides a good support effect at the same time.

In this embodiment, as shown in FIG. 9, both sides within the insertion slot 22 are provided with position limiting protrusions 221. The position limiting protrusion 221 is arranged along a length direction of the insertion slot 22. When the connecting rod 41 is pivotally connected to the insertion slot 22, the connecting rod 41 is partially positioned between the position limiting protrusions 221. Through the arrangement of the above structure, the position limiting protrusions 221 are provided on both sides within the insertion slot 22. When the connecting rod 41 is pivotally connected to the insertion slot 22, the connecting rod 41 is partially positioned between the position limiting protrusions 221. Through the guiding and position limiting effect of the position limiting protrusions 221, the connecting rod 41 is effectively prevented from deflecting during movement, improving the stability and reliability of the use of the product.

In this embodiment, the first part 13 is substantially rectangular, and the second part 14 is substantially in an arc shape. Through the arrangement of the above structure, the first part 13 adopts a design of the irregular trapezoid, which, combined with the arc-shaped structure of the second part 14, can optimize the overall force and ensure a smooth fishing process.

In this embodiment, as shown in FIG. 9, a length of the position limiting protrusion 221 is less than a length of the insertion slot 22. The length of the position limiting protrusion 221 is designed to be less than the length of the insertion slot 22, which can ensure the effective guiding effect on the connecting rod 41 without affecting the normal insertion of the slidable unlocking member 3 in the insertion slot 22.

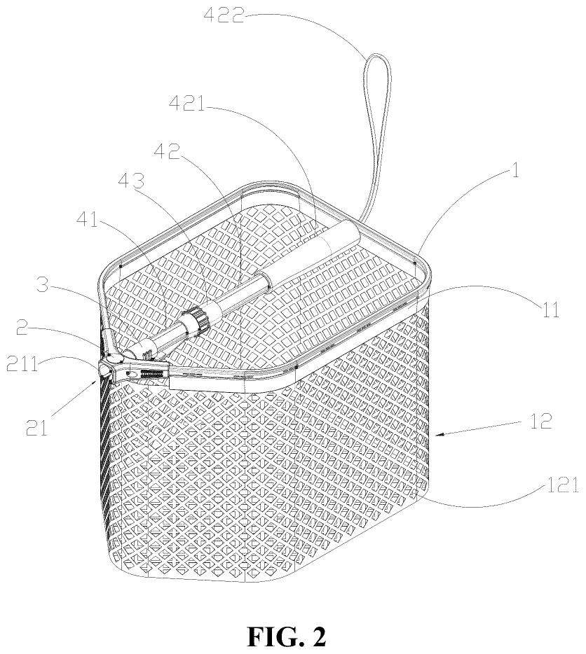

In this embodiment, as shown in FIGS. 1-2, the slidable unlocking member 3 includes a locking part 31 and a sliding part 32. The sliding part 32 and the locking part 31 are slidably arranged on the connecting rod 41. When the locking part 31 is inserted into the insertion block 2, the sliding part 32 abuts against the insertion block 2. Through the arrangement of the above structure, it is preferred that the sliding part 32 and the locking part 31 are integrally formed, and an outer diameter of the locking part 31 is designed to precisely match an inner cavity of the insertion block 2. An outer diameter of the sliding part 32 is larger than the outer diameter of the locking part 31, and a stepped structure is formed through this diameter difference, effectively preventing the sliding part 32 from being inserted into the insertion block 2. A front end of the connecting rod 41 is equipped with a small diameter section for being inserted into the insertion block 2, and a rear end of the connecting rod 41 is equipped with a large diameter section for installing the sliding part 32, ensuring that the connecting rod 41 is movable inside the insertion block 2 after insertion, so that the rod member 4 can be stacked on the net frame 1. When it is necessary to fix the fishing net in the usage state, the locking part 31 is inserted into the first opening 211 of the insertion block 2. At this time, the rod member 4 and the net frame 1 are in the locked state, which facilitates fishing operations. When the fishing net needs to be folded, the sliding part 32 is pushed down, and the sliding part 32 drives the locking part 31 to disengage from the first opening 211 to be in an unlocked state. When unlocked, the connecting rod 41 is capable of sliding through the second opening 212 to the third opening 213, and the locking part 31 is inserted into the insertion block 2 through the third opening 213 to complete folding and locking.

In this embodiment, as shown in FIG. 6, the slidable unlocking member 3 is internally equipped with a restoration spring 33. The connecting rod 41 is equipped with a stop portion 411. The stop portion 411 is positioned inside the slidable unlocking member 3. The restoration spring 33 is sleeved on the connecting rod 41. A first end of the restoration spring 33 abuts against an inner wall of an end portion of the locking part 31, and a second end of the restoration spring 33 abuts against the stop portion 411. When the sliding part 32 is subjected to an external force, the sliding part 32 is capable of driving the locking part 31 to disengage from within the insertion block 2. The restoration spring 33 is used for driving the sliding part 32 and the locking part 31 to return to an initial position. Through the arrangement of the above structure, the restoration spring 33 is sleeved on the small diameter section of the connecting rod 41. The first end of the restoration spring 33 abuts against an inner end surface of the locking part 31, and the second end abuts against the stop portion 411. When the sliding part 32 slides downwards along the connecting rod 41 under the external force, the restoration spring 33 is compressed, driving the locking part 31 to disengage from the insertion block 2. After the external force is released, an elastic force of the restoration spring 33 drives the sliding part 32 and the locking part 31 to return to the initial position, allowing the locking part 31 to be inserted into the insertion block 2 again, achieving the locking of the rod member 4 and the net frame 1.

As shown in FIG. 1, FIG. 2, and FIG. 6, in a first embodiment, the sliding part 32 is provided with a hook 321, and the hook 321 is bent and extends along an end portion of the sliding part 32 in a direction towards the extending rod 42. Through the arrangement of the above structure, it is preferred that the hook 321 and the sliding part 32 are integrally arranged, and an anti-slip texture is used on a surface to facilitate the user to better push the sliding part 32 through the hook 321. An additional hanging function is also provided, which can be used for hanging other items, making functions of the product more complete.

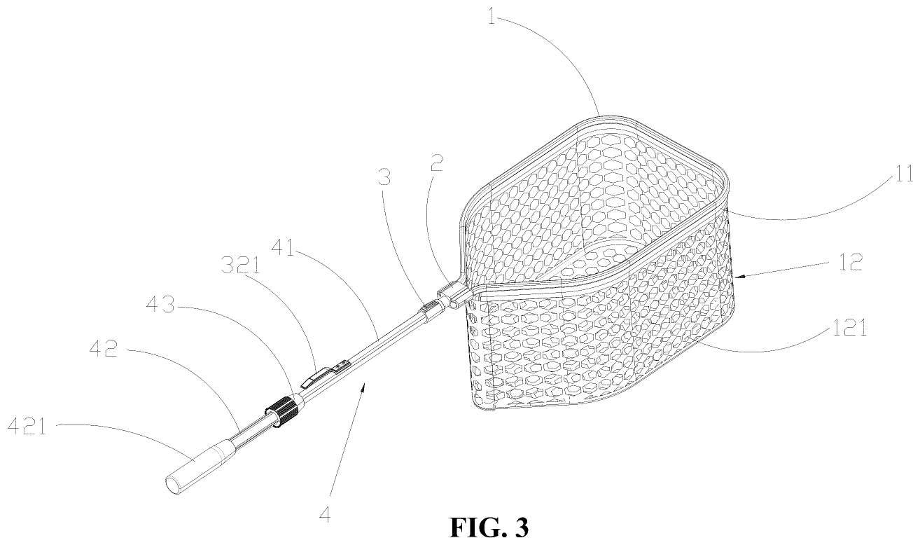

As shown in FIG. 3, in a second embodiment, the connecting rod 41 is provided with a hook 321, and the hook 321 is bent and extends along the connecting rod 41 in a direction towards the extending rod 42. Through the arrangement of the above structure, the hook 321 is detachably fixed to the connecting rod 41 through screws. The hook 321 can be used for temporarily hanging the fishing net on an edge of a boat or a shore, and can also be used for hanging other items, thereby making functions of the product more complete.

In this embodiment, as shown in FIG. 9, a rotating shaft 23 is also provided inside the insertion block 2. A rotating hole 412 adapted to the rotating shaft 23 is defined in the connecting rod 41. The rotating hole 412 cooperates with the rotating shaft 23, so that the connecting rod 41 is pivotally connected into the insertion block 2. Through the arrangement of the above structure, the rotating shaft 23 is arranged inside the insertion block 2, which is matched with the rotating hole 412 on the connecting rod 41. The rotating shaft 23 and the rotating hole 412 cooperate to form a stable pivot structure, ensuring the flexibility of rotation of the connecting rod 41.

In this embodiment, a tail end of the extending rod 42 is provided with a hanging rope 422. Through the arrangement of the above structure, the hanging rope 422 is arranged at the tail end of the extending rod 42, providing the user with an additional fixing point, and achieving fixation by fastening the rope according to the actual needs.

In this embodiment, both the first floating member 11 and the second floating member 421 are made of floating materials. Through the arrangement of the above structure, the first floating member 11 and the second floating member 421 are made of floating materials, and the floating materials can be one or more of polyethylene, polyurethane, polystyrene foaming materials. These materials not only have excellent buoyancy performance, but also have good durability, and at the same time are lightweight, easy to carry, and low-cost.

In this embodiment, the fishing net 12 is equipped with a plurality of grids 121. The grids 121 are all arranged in a diamond shape. Through the arrangement of the above structure, the fishing net 12 adopts a design of the diamond-shaped net frame 121, which is not only beneficial for capturing fish and preventing the fish from escaping, but also easy to clean and maintain.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

1. A portable fishing net, comprising:
a net frame;
an insertion block;
a slidable unlocking member; and
a rod member;
wherein the insertion block is disposed on the net frame; the slidable unlocking member is slidably arranged on the rod member; the slidable unlocking member is capable of being inserted into the insertion block; when the slidable unlocking member is inserted into the insertion block, the rod member and the net frame are in a locked state; when the slidable unlocking member is disengaged from the insertion block, the rod member is movable relative to the net frame, and the rod member is movable to be stacked on the net frame;
wherein the rod member comprises a connecting rod and an extending rod, the slidable unlocking member is slidably arranged on the connecting rod, the connecting rod is pivotally connected into the insertion block, and the extending rod is slidable relative to the connecting rod;
wherein a plurality of openings are defined in the insertion block, when the slidable unlocking member is inserted into the insertion block through at least one of the plurality of openings, the connecting rod and the net frame are in a locked state; the plurality of openings comprise a first opening, a second opening, and a third opening, with the first opening and the third opening located at two ends of the second opening and in communication with the second opening, and the first opening, the second opening, and the third opening being open and exposed at a lower surface the insertion block; when the slidable unlocking member is inserted into the insertion block through the first opening, the connecting rod and the extending rod are in a usage state relative to the net frame; when the slidable unlocking member is disengaged from the locked state, the slidable unlocking member together with the rod member is capable of being rotated from the first opening to the third opening through the second opening from the lower surface the insertion block; and when the slidable unlocking member is inserted into the insertion block through the third opening, the rod member and the net frame are in a folded state.

2. (canceled)

3. The portable fishing net according to claim 1, wherein the rod member further comprises a locking member; the locking member is arranged between the connecting rod and the extending rod; and the locking member is used for fixing the connecting rod and the extending rod.

4. (canceled)

5. (canceled)

6. The portable fishing net according to claim 3, wherein a bottom portion of the net frame comprises a first floating member; the extending rod is provided with a second floating member; the first floating member is installed on the net frame; and the second floating member is sleeved on a tail end of the extending rod.

7. The portable fishing net according to claim 1, wherein the insertion block is also provided with an insertion slot; the insertion slot penetrates between the first opening and the third opening; the connecting rod is capable of being pivotally connected into the insertion slot through the first opening and the third opening; and the slidable unlocking member is capable of being inserted into the insertion slot.

8. The portable fishing net according to claim 6, wherein the bottom portion of the net frame is also equipped with a fishing net; and the fishing net is fixedly connected to a bottom portion of the first floating member.

9. The portable fishing net according to claim 6, wherein the net frame comprises a first part and a second part; the first part is in a closed form; the second part comprises two free ends; and the insertion block used for detachably fixing the connecting rod is connected to the two free ends respectively.

10. The portable fishing net according to claim 7, wherein both sides within the insertion slot are provided with position limiting protrusions; each of the position limiting protrusions is arranged along a length direction of the insertion slot; and when the connecting rod is pivotally connected in the insertion slot, the connecting rod is partially positioned between the position limiting protrusions.

11. The portable fishing net according to claim 9, wherein the first part is substantially rectangular; and the second part is substantially in an arc shape.

12. The portable fishing net according to claim 10, wherein a length of each of the position limiting protrusions is less than a length of the insertion slot.

13. The portable fishing net according to claim 1, wherein the slidable unlocking member comprises a locking part and a sliding part; the sliding part and the locking part are slidably arranged on the connecting rod; and when the locking part is inserted into the insertion block, the sliding part abuts against the insertion block.

14. The portable fishing net according to claim 13, wherein the slidable unlocking member is internally equipped with a restoration spring; the connecting rod is equipped with a stop portion; the stop portion is positioned inside the slidable unlocking member; the restoration spring is sleeved on the connecting rod; a first end of the restoration spring abuts against an inner wall of an end portion of the locking part; a second end of the restoration spring abuts against the stop portion; when the sliding part is subjected to an external force, the sliding part is capable of driving the locking part to disengage from within the insertion block; and the restoration spring is used for driving the sliding part and the locking part to return to an initial position.

15. The portable fishing net according to claim 14, wherein the sliding part is provided with a hook; and the hook is bent and extends along an end portion of the sliding part in a direction towards the extending rod.

16. The portable fishing net according to claim 14, wherein the connecting rod is provided with a hook; and the hook is bent and extends along the connecting rod in a direction towards the extending rod.

17. The portable fishing net according to claim 1, wherein a rotating shaft is also provided inside the insertion block; a rotating hole adapted to the rotating shaft is defined in the connecting rod; and the rotating hole cooperates with the rotating shaft, so that the connecting rod is pivotally connected into the insertion block.

18. The portable fishing net according to claim 1, wherein a tail end of the extending rod is provided with a hanging rope.

19. The portable fishing net according to claim 6, wherein both the first floating member and the second floating member are made of floating materials.

20. The portable fishing net according to claim 8, wherein the fishing net is equipped with a plurality of grids; and the plurality of grids are all arranged in a diamond shape.

21. A portable fishing net, comprising:
a net frame;
an insertion block;
a slidable unlocking member; and
a rod member;
wherein the insertion block is disposed on the net frame; the slidable unlocking member is slidably arranged on the rod member; the slidable unlocking member is capable of being inserted into the insertion block; when the slidable unlocking member is inserted into the insertion block, the rod member and the net frame are in a locked state; when the slidable unlocking member is disengaged from the insertion block, the rod member is movable relative to the net frame, and the rod member is movable to be stacked on the net frame;
wherein the rod member comprises a connecting rod and an extending rod slidable relative to the connecting rod, the net frame is provided with a first floating member, the extending rod is provided with a second floating member, the first floating member is in ring-shaped and sleeved on the net frame, the second floating member is sleeved on a tail end of the extending rod, a bottom portion of the net frame is equipped with a fishing net, and the fishing net is fixedly connected to a bottom portion of the first floating member; and
wherein the first floating member comprises a double-layer structure including an outer covering body and a built-in floating material built-in and enclosed by the outer covering body; an upper portion of the outer covering body is provided with an installation block, and the net frame comprises a slot adapted to the installation block, thereby preventing the first floating member from detaching from the slot.

22. The portable fishing net according to claim 21, wherein the outer covering body is made of water-resistant woven material, and forms a closed covering cavity for accommodating the built-in floating material.

23. The portable fishing net according to claim 1, wherein the insertion block comprises two ends extending outwards from opposite side walls of the third opening respectively, and the two ends of the insertion block are fixed to the net frame with screws.
